(19) United States
(12) Patent Application Publication
(10) Pub. No.: US 2005/0084708 A1
(43) Pub. Date: Apr. 21, 2005

(54) Organic EL display panel

(76) Inventors: Daisaku Haoto, Tokyo-to (JP); Kenji Tanaka, Tokyo-to (JP); Minoru Komada, Tokyo-to (JP)

Correspondence Address: LADAS & PARRY LLP, 224 SOUTH MICHIGAN AVENUE, SUITE 1200, CHICAGO, IL, 60604, US

(21) Appl. No.: 10/755,931

(22) Filed: Jan. 13, 2004

(30) Foreign Application Priority Data
Jan. 16, 2003 (JP) P2003-008630
Sep. 30, 2003 (JP) P2003-339462

(51) Int. Cl. H05B 33/00

(52) U.S. Cl. 428/690; 428/917; 428/212; 428/702; 313/504; 313/506; 313/512; 313/112; 257/98

(57) ABSTRACT

The main object is to provide an organic EL display panel capable of achieving the electromagnetic wave blocking effect without providing newly an electromagnetic wave blocking layer, and to provide an organic EL display panel having a barrier film with an uniform composition even in the case it is produced using an in line type device, capable of preventing the light emission deterioration of the organic EL due to the gas outputted from the base member, such as the oxygen and the moisture. The organic EL display panel comprises a base member, an organic EL element, and a barrier layer provided between the base member and the organic EL element, wherein the barrier layer comprises two kinds of laminated inorganic films, the inorganic film on the base member side out of the two kinds of the inorganic films is an inorganic oxide film having the conductivity, and the inorganic film on the organic EL element side is an inorganic film having the gas barrier property and the insulation property.

### BACKGROUND OF THE INVENTION

1. Field of the Invention

The present invention relates to an organic EL (electro-luminescence) display panel. More specifically, it relates to an organic EL display panel having a barrier layer, capable of effectively preventing the gas generated from a base member and capable of preventing the electromagnetic wave.

2. Description of the Related Art

The organic EL elements are electric field light emitting (EL) elements for changing an organic substance including a carbon, or the like into a light emitting matter, for emitting a light beam by applying a voltage to an organic fluorescent substance (organic light emitting layer) such as diamines interposed between a plus electrode and a minus electrode on a base member. Since the organic EL elements are the so-called self light emitting devices without the need of another light source such as a back light and it is advantageous, the display devices (display) using the organic EL element have been developed.

Since the light emitting characteristics of the organic light emitting layer of the organic EL elements can be deteriorated by the moisture content or the oxygen, it is necessary to block the gas outputted from the base member such as the moisture content and the oxygen. Therefore, in the case of using a glass base member to have a large quantity of the gas to be outputted, an organic EL element of an embodiment provided with a barrier film for preventing the outputted gas so as to prevent the deterioration of the light emitting characteristics of the organic light emitting layer by the moisture content, the oxygen, or the like, is known. It is known that the barrier film is formed by a vacuum deposition method such as a sputtering method, a CVD method, an ion plating method (For example, Japanese Patent Application Laid Open No. 2002-100469).

According to the organic EL display panel, conventionally, a function of blocking the electro magnetic wave may be needed, and at the time, an electro magnetic wave blocking layer is newly provided.

### SUMMARY OF THE INVENTION

However, for providing the electromagnetic wave blocking layer newly into the configuration of the organic EL display panel, the work process for that purpose becomes complicated so that a problem of the cost increase is involved.

Furthermore, as another problem, the conventionally known barrier film is formed only by depositing merely one kind of an inorganic oxide (for example, a silicon nitride oxide in the above Patent Document) on a base member so that it is affected by the outputted gas from the base member in the stage of forming the barrier film itself so as not to evenly form a barrier film, and thus it is problematic. In particular, in the case the barrier film is formed, using an in-line type (transmission film formation type) device, irregularity is generated in terms of the outputted gas amount from the base member, depending on the position of the base member (for example, the top end part and the rear end part of the base member), it has been extremely difficult to form a barrier film with an even composition.

In view of the situation, the present invention has been achieved, and the main object thereof is to provide an organic EL display panel capable of achieving the electromagnetic wave blocking effect without the need of newly providing an electromagnetic wave blocking layer, and to provide an organic EL display panel having a barrier film with an even thickness even in the case it is produced, using an in-line type device, capable of preventing the light emission deterioration of the organic EL due to the gas outputted from the base member, such as the oxygen and the moisture content.

A first aspect of the present invention is an organic EL display panel, comprising a base member, an organic EL element, and a barrier layer provided between the base member and the organic EL element, wherein the barrier layer comprises two kinds of laminated inorganic films, the inorganic film on the base member side out of said two kinds of the inorganic films is an inorganic oxide film having the conductivity, and the inorganic film on the organic EL element side is an inorganic oxide film having the gas barrier property and the insulation property.

According to the organic EL display panel, since the barrier film is formed by laminating the two kinds of the inorganic films, and the inorganic oxide film having the conductivity is used as the inorganic film on the base member side out of the two kinds of the inorganic films, the electromagnetic wave blocking effect can be provided to the barrier layer, which has conventionally been present in the organic EL display panel.

Moreover, according to the organic EL display panel, since the inorganic oxide film having the gas barrier property capable of preventing the gas outputted from the base member and the insulation property is formed on the organic EL element side, the organic EL display panel can be used as an active matrix method display panel. Furthermore, since the inorganic oxide film having the conductivity formed on the base member side functions as a capping layer (layer for blocking the gas outputted from the base member) at the time of forming the inorganic oxide film formed on the organic EL element side, the composition of the inorganic oxide film formed on the organic EL element side can be even.

According to the above-mentioned organic EL display panel, the inorganic film on the base member side out of the two kinds of the inorganic films forming the barrier layer may be made of either of an indium tin oxide or an indium zinc oxide, and the inorganic film on the organic EL element side may be made of an aluminum nitride, a silicon nitride oxide, a silicon oxide, or an aluminum oxide.

Moreover, according to the above-mentioned organic EL display panel, the two kinds of the inorganic films forming the barrier layer may be formed by the sputtering method.

Furthermore, according to the above-mentioned organic EL display panel, a color filter may be provided facing the base member with the organic EL element interposed therebetween, and the color filter may have the gas barrier property and the conductivity.

In the case of an organic EL display panel of the so-called top emission method (type with the light beam transmitted from the side opposite to the base member), the color filter can be provided, facing the base member with the organic EL element interposed therebetween, by providing the gas barrier property and the conductivity to the color filter in this case, the organic EL element deterioration can be prevented, and the electromagnetic wave blocking effect can be provided to the color filter.

The present invention further includes many embodiments other than those to be described in detail hereafter. Moreover, those involved in the field understand that the present invention include many other embodiments with change or modification without departing from the idea or scope of the present invention defined only by the attached claims based on the detailed description hereafter.

### BRIEF DESCRIPTION OF THE DRAWINGS

FIG. 1 is a schematic cross-sectional view showing an embodiment of an organic EL display panel according to the present invention.

FIG. 2 is a diagram showing the measured parts for comparing the example 1 and the comparative example 1.

FIG. 3 is a schematic cross-sectional view showing an organic EL display panel according to the example 2 of the present invention.

Respective numerals in the figures denote respective members as follows;
10 . . . organic EL display panel, 11 . . . base member, 12 . . . organic EL element, and 13 . . . barrier layer.

### PREFERRED EMBODIMENTS OF THE INVENTION

Hereinafter, the organic EL display panel of the present invention will be explained specifically with reference to the drawings.

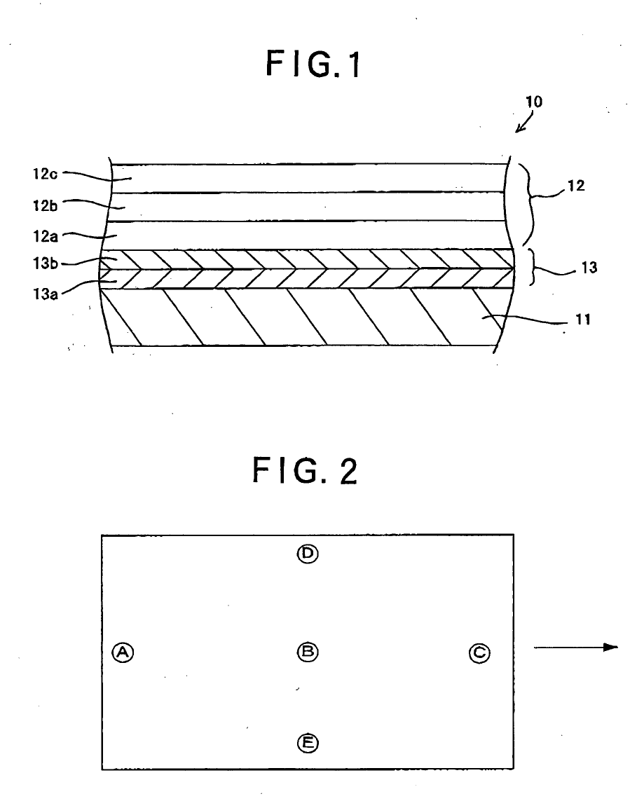

FIG. 1 is a schematic cross-sectional view for explaining the configuration of the organic EL display panel of the present invention.

As shown in FIG. 1, the organic EL display panel 10 of the present invention comprises a base member 11, an organic EL element 12, and a barrier layer 13 provided between the base member 11 and the organic EL element 12. The barrier layer 13 is formed by laminating two kinds of inorganic films (13a, 13b) Out of the two kinds of the inorganic films (13a, 13b), the inorganic film 13a on the base member side is an inorganic oxide film having the conductivity, and the inorganic film 13b on the organic EL element side is an inorganic oxide film having the gas barrier property and the insulation property.

By forming the barrier film 13 accordingly by the two kinds of the inorganic films (13a, 13b), since the inorganic film 13a on the base member side is an inorganic oxide film having the conductivity, the electromagnetic wave blocking performance can be provided to the organic EL display panel of the present invention, and the inorganic film 13a can block the gas outputted form the base member 11, the influence of the outputted gas can be avoided at the time of forming the inorganic film 13b on the organic EL element side, and consequently the composition of the inorganic film 13b can be made even.

Hereinafter, the configuration of the organic EL display panel 10 of the present invention will be each explained in detail.

[1] Base member

The base member 11 of the organic EL display panel 10 in the present invention is the configuration necessary for supporting the organic EL element. The material, or the like is not particularly limited as long as the function can be performed, and any known base member such as a glass substrate and a resin substrate or the like can be used. Then, according to the organic EL display panel 10 of the present invention, a resin substrate containing a large amount of the moisture content, or the like can be used as well. According to the conventional organic EL display panel 10, in the case the resin substrate containing a large amount of the moisture content, or the like is used, due to a large amount of the gas outputted from the substrate, a trouble can be generated frequently at the time of forming the barrier layer. However, according to the present invention, since the barrier layer is provided in the two layer structure (13a, 13b), and the inorganic layer 13a on the base member side is a layer without being affected by the outputted gas (details thereof will be described later), the barrier performance cannot be deteriorated even in the case a resin substrate with a large amount of the outputted gas is used.

[2] Organic EL element

The organic EL element 12 in the present invention is a conventionally known organic EL element. For example, it comprises a first display electrode 12a, an organic function layer 12b including a light emitting layer made of an organic compound, and a second display electrode 12c.

[3] Barrier layer

The barrier layer in the organic EL display panel 10 of the present invention is provided between the above-mentioned base member 11 and the organic EL element 12. It is provided by laminating two kinds of inorganic films (13a, 13b). Out of the two kinds of the inorganic films (13a, 13b), the inorganic film 13a on the base member side is an inorganic oxide film having the conductivity, and the inorganic film 13b on the organic EL element side is an inorganic film having the gas barrier property and the insulation property.

Hereinafter, each inorganic film will be explained.

(1) Inorganic Film 13a on the Base Member Side (Inorganic Oxide Film Having the Conductivity)

Out of the inorganic films forming the barrier layer, the inorganic film 13a on the base member side is made of an inorganic oxide having the conductivity, which plays the role of providing the electromagnetic wave blocking function to the organic EL display panel 10 of the present invention, and the role of the so-called capping layer for blocking the gas outputted from the base member at the time of forming the inorganic film 13b on the organic EL element side, which is to be described later.

As the inorganic film 13a, any one can be used as long as it is an inorganic oxide film having the conductivity, however, a film made of an indium tin oxide (so-called ITO film) or a film made of an indium zinc oxide (IZO film) are preferable. Among these films, in particular, a film made of an indium tin oxide formed at a low temperature is preferable. As mentioned above, since the inorganic film 13a has the role of blocking the gas outputted from the base member, and the film made of an indium tin oxide formed at a low temperature becomes an amorphous oxide film, the outputted gas can be blocked effectively and the influence of the outputted gas can hardly be posed at the time of forming the inorganic film 13a.

The method for forming the inorganic film 13a is not particularly limited as long as it is a method of forming a film in a vacuum state. For example, the vacuum deposition methods such as the sputtering method, the CVD method, and the ion plating method, or the like can be presented. Among them, the sputtering method can be used preferably.

As to the condition for forming the inorganic film 13a by the sputtering method, it can be set optionally according to the kind of the inorganic film 13a to be formed. For example, in the case of forming an IZO film, since the IZO film can always maintain the amorphous structure, there is no risk of generating a problem in terms of the barrier property, and thus the formation condition needs not be limited particularly. In contrast, in the case of forming an ITO film, since the ITO film generates the crystal grain boundary growth, it is preferable to form a film in a state with a high H₂O partial pressure (specifically, 5×10⁻⁴ Pa or more H₂O partial pressure), or to form a film at a low temperature without heating. As to the condition in the case of forming the ITO film by the sputtering method, one can refer to “Etching Characteristic and Film Formation Condition of TFT/LCD Sputtering ITO film, IBM Japan: Hiroaki Kitahara, et, al., Transparent Conductive Film Symposium text, H13. 4. 16, Hosted by (Social Corporation) Surface Technology Association”, or the like.

Moreover, as to the film thickness of the inorganic film 13a, it is not particularly limited as long as it is a film thickness of the degree capable of achieving the above-mentioned function. For ensuring the visible light transmittance , the interference of the light should be taken into consideration. Specifically, a film thickness (d) satisfying the following formula (Formula 1) is preferable.
qλ=4nd, (Formula 1)
wherein q represents a natural number (1, 2, 3 . . . ), n the refractive index, d the film thickness, and λ the wavelength, respectively.

For example, by substituting the reference values (q=1, 2, 3 . . . , n=1.8 to 2.0, λ=550) in the above-mentioned formula, the film thickness d can be calculated as 700 Å, 1,500 Å, 2,200 Å, 3,000 Å . . . .

(2) Inorganic Film 13b on the Organic EL Element Side (Inorganic Oxide Film Having the Gas Barrier Property and the Insulation Property)

Out of the inorganic films forming the barrier layer, the inorganic film 13b on the organic EL element side is made of an inorganic oxide having the gas barrier property and the insulation property. It protects the organic EL element 12 in the organic EL display panel 10 of the present invention from the gas outputted from the base member 11, and plays the function of having the organic EL display panel 10 usable for the active matrix method display panel (insulation property).

The active matrix method includes the top emission method (transmit the light on the side opposite to the base member) and the bottom emission method (transmit the light from the base member side). In the case of the top emission method, a color filter for correcting the light color is used frequently. In this case, by providing the barrier property and the conductivity to the color filter, the deterioration of the organic EL element can be prevented, and the electromagnetic wave blocking effect can be provided to the color filter.

As the inorganic film 13b, any one can be used as long as it is an inorganic oxide film having the gas barrier property and the insulation property. However, an aluminum nitride, a silicon nitride oxide, a silicon oxide, and an aluminum oxide are preferable. Among these films, in particular, a film made of a silicon nitride oxide (SiOxNy) is preferable because a film made of a silicon nitride oxide (SiOxNy) has the excellent barrier property.

The method for forming the inorganic film 13b is not particularly limited as long as it is a method of forming a film in a vacuum state. For example, the vacuum deposition methods such as the sputtering method, the CVD method, and the ion plating method, or the like can be presented. Among them, the sputtering method can be used preferably.

As to the condition for forming the inorganic film 13b by the sputtering method, for example, in the case of forming an SiO₂ film as the inorganic film 13b, the conditions including the film formation pressure of 0.5 Pa, the Ar/O₂ flow rate of 400/5 sccm, the input power of 4.3 kw, the target material of an SiO₂ (size: 126 mm×520 mm), the power density of 4.3/655.2 cm² =6.56 w/cm², and the film thickness of 3,000 Å are preferable. In particular, at the time of forming a film made of a silicon nitride oxide (SiOxNy), the conditions including the film formation pressure of 0.5 Pa, the Ar/O₂ flow rate of 400/10 sccm, the input power of 4.3 kw, the target material of an Si₃N₄ (size: 126 mm×520 mm), the power density of 4.3/655.2 cm²=6.56 w/cm², and the film thickness of 3,000 Å are preferable.

Moreover, as to the film thickness of the inorganic film 13b, it is not particularly limited as long as it is a film thickness to the degree capable of achieving the above-mentioned function, and specifically it is preferably 500 to 5,000 Å.

### EXAMPLES

### Example 1

A PES film (polyether sulfone film) having a thickness of 200 μm, and a size of 300 cm×400 cm was used as the base member. Then, an IZO film was formed on the surface of the base member as the inorganic film on the base member side (see the numeral 13a in FIG. 1) as the barrier layer, using a sputtering device. Furthermore, a silicon nitride oxide film was formed on the surface of the IZO film as the organic EL element side inorganic film (see the numeral 13b in FIG. 1). The film formation conditions are shown herein below, respectively.

<Inorganic Film on the Base Member Side (IZO Film)>

Target material: IZO (produced by Idemitsu Kosan K.K.)

Ar/O₂: 100 sccm/1.5 sccm

Film formation pressure: 5 mmTorr

Applied power: 2.5 kw

Film formation temperature: non-heating (about 27 C)

Film thickness: 500 Å

Conveyance speed: 290 mm/minute

<Inorganic Film on the Organic EL Element Side (Silicon Nitride Oxide Film)>

Target material: SiN (produced by Toshima Seisakusho K. K.)

Ar/N₂: 400 sccm/10 sccm (40:1)

Film formation pressure: 5 mmTorr

Applied power: 4.3 kw

Film formation temperature: non-heating (about 110 C)

Film thickness: 2,500 Å

Conveyance speed: 58 mm/minute

For monitoring the gas during the film formation, a quadrupole mass analysis device produced by Alback Corp. (STADAM-2000) was used. Three carriers were used (first carrier: for ESCA (Si wafer/film), second carrier: film thickness, transmittance measurement (glass), and third carrier: film (barrier measurement); all are of the same batch).

### Comparative Example 1

As the Comparative Example 1, the Example 1 was repeated under the same conditions, except that a silicon nitride oxide film was formed directly on the base member without forming the inorganic film on the base member side (IZO film) in the above-mentioned Example 1 of the present invention.

### Result of Comparison Between the Example 1 and the Comparative Example 1

For comparing the barrier film of the Example 1 and the barrier film of the Comparative Example 1, the in-plane composition, the transmittance, and the barrier property in predetermined parts of the base member (see A to E shown in FIG. 2) were measured. The measurement results are shown in the following table 1 (Example 1) and table 2 (Comparative Example 1), respectively.

The measured parts were the parts of 2 cm from the end of the base member, and for the barrier measurement by the Mokon method, the vicinity of the measured parts were cut by 9 cm×9 cm was cut out and measured. Moreover, as to the conveying direction of the base member (direction to be conveyed to the sputtering device), C in FIG. 2 is the top end and A is the rear end.

Moreover, the composition analysis was executed by the ESCA. At the time, an Si wafer was placed on the base member at the A to E positions for the composition analysis. This was formed by the same batch of a carrier different from that for the film thickness, barrier and transmittance measurement. For the measurement, the value dug to about 100 Å and the value of the uppermost surface were measured. The values did not differ significantly, and for the above-mentioned value, the value of the uppermost surface is shown.

Moreover, also as to the film thickness measurement, a film formed on a glass, using another carrier similarly in the case of the above-mentioned composition analysis, was peeled off by the lift off method, and evaluated.

TABLE 1

| | | | Total film | Water vapor | Oxygen |
|---|---|---|---|---|---|
| | Composition | Transmittance | Thickness | barrier | barrier |
| | (Si/O/N) | (%) | (Å) | (WTR) | (OTR) |
| A | 100/71/80 | 85 | 3000 | 0.015 | 0.11 |
| B | 100/70/81 | 86 | 3000 | 0.016 | 0.10 |
| C | 100/70/80 | 85 | 3000 | 0.014 | 0.10 |
| D | 100/70/81 | 86 | 2900 | 0.016 | 0.10 |
| E | 100/71/81 | 86 | 2900 | 0.013 | 0.11 |

TABLE 2

| | | | Total film | Water vapor | Oxygen |
|---|---|---|---|---|---|
| | Composition | Transmittance | Thickness | barrier | barrier |
| | (Si/O/N) | (%) | (Å) | (WTR) | (OTR) |
| A | 100/74/80 | 80 | 3000 | 0.035 | 0.18 |
| B | 100/82/71 | 85 | 3000 | 0.041 | 0.21 |
| C | 100/99/64 | 98 | 3000 | 0.075 | 0.24 |
| D | 100/83/72 | 87 | 2900 | 0.032 | 0.22 |
| E | 100/84/71 | 86 | 2900 | 0.032 | 0.21 |

As it is apparent from the above-mentioned tables, the barrier layer of the Example 1 is superior to the Comparative Example 1 in terms of both the water vapor barrier property (WTR) and the oxygen barrier property (OTR), and furthermore, it was shown that the barrier performance thereof is constant without irregularity in any of the parts A to E, and thus it represents the even formation of the barrier film.

### Example 2

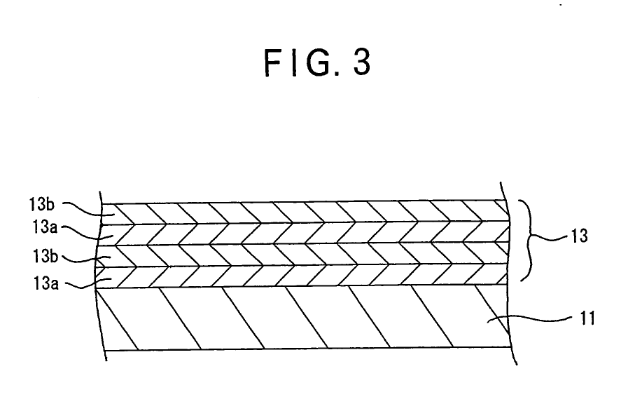

A repeated structure of the barrier film described in the Example 1, that is, one having inorganic films laminated in the order of an IZO film-silicon nitride oxide film-IZO film-silicon nitride oxide film on the base member was formed (see FIG. 3). The film formation conditions were same as those in the Example 1.

The transmittance of the barrier layer according to the Example 2 was measured, and it was revealed that it was a 84% transmittance with the glass substrate as the reference, and it is at the practical use level. Moreover, the resistance of the barrier layer was measured to be 30 Ω/□, and it is considered to have the sufficient electromagnetic wave preventing performance.

As heretofore explained, according to the present invention, since a barrier film is formed by laminating two kinds of the inorganic films, and an inorganic oxide film having the conductivity is used as the inorganic film on the base member side out of the two kinds of the inorganic films, an electromagnetic wave blocking effect can be provided to the barrier layer, which has been present conventionally in the organic EL display panel

Moreover, according to the organic EL display panel, since the inorganic oxide film having the gas barrier property capable of preventing the gas outputted from the base member and the insulation property is formed on the organic EL element side, the organic EL display panel can be used as an active matrix method display panel. Furthermore, since the inorganic oxide film having the conductivity formed on the base member side functions as a capping layer (layer for blocking the gas outputted from the base member) at the time of forming the inorganic oxide film formed on the organic EL element side, the composition of the inorganic oxide film formed on the organic EL element side can be made even.

1. An organic EL (electroluminescene) display panel, comprising a base member, an organic EL element, and a barrier layer provided between the base member and the organic EL element.
wherein the barrier layer comprises two kinds of laminated inorganic films, the inorganic film on the base member side out of the two kinds of the inorganic films is an inorganic oxide film having the conductivity, and the inorganic film on the organic EL element side is an inorganic film having the gas barrier property and the insulation property.

2. The organic EL display panel according to claim 1, wherein the inorganic film on the base member side out of the two kinds of the inorganic films forming the barrier layer is made of either of an indium tin oxide or an indium zinc oxide, and the inorganic film on the organic EL element side is made of an aluminum nitride, a silicon nitride oxide, a silicon oxide, or an aluminum oxide.

3. The organic EL display panel according to claim 1, wherein the two kinds of the inorganic films forming the barrier layer are formed by the sputtering method.

4. The organic EL display panel according to claim 1, wherein the barrier layer comprising the two kinds of the laminated inorganic films is formed by laminating two or more layers repeatedly.

5. The organic EL display panel according to claim 1, wherein a color filter is provided facing the base member with the organic EL element interposed therebetween, and the color filter has the gas barrier property and the conductivity.
